(19) United States
(12) Patent Application Publication
(10) Pub. No.: US 2013/0155855 A1
(43) Pub. Date: Jun. 20, 2013

(54) Increasing Efficiency of Admission Control in a Network

(71) Applicants: Joachim Kross, Munchen (DE); Daniela Laselva, Klarup (DK); Jeroen Wigard, Klarup (DK)

(72) Inventors: Joachim Kross, Munchen (DE); Daniela Laselva, Klarup (DK); Jeroen Wigard, Klarup (DK)

(73) Assignee: Nokia Siemens Networks Oy, Espoo (FI)

(21) Appl. No.: 13/814,798

(22) PCT Filed: Aug. 9, 2010
(86) PCT No.: PCT/EP2010/061564

§ 371 Date: Mar. 4, 2013

(51) Int. Cl. H04W 28/02

(52) U.S. Cl. CPC H04W 28/0215
USPC 370/230

(57) ABSTRACT

An apparatus and a method is provided, by which a penetration of terminals supporting a congestion indication scheme in a network or a part of the network is determined, and a load threshold is dynamically adjusted according to the penetration of terminals supporting a congestion indication scheme, wherein the load threshold is used for controlling load in the network or the part of the network.

### FIELD OF THE INVENTION

The present invention relates to apparatuses, methods and a computer program product for increasing efficiency of admission control in a network.

### RELATED BACKGROUND ART

The following meanings for the abbreviations used in this specification apply:

3GPP 3^{rd} generation partnership project

AC Admission control

AMR Adaptive multi rate

ECN Explicit congestion notification

eNode-B LTE base station (also referred to as eNB)

EPC Evolved packet core

GBR Guaranteed bit rate

GSM Global system for mobile communications

IP Internet protocol

LC Load control

LTE Long term evolution

LTE-A LTE-Advanced

MS Mobile station

MSISDN Mobile station integrated services data network

PS Packet scheduling

QoS Quality of Service

RAB Radio bearer

RAN Radio access network

RTCP Real-time transport control protocol

RTP Real-time transport protocol

UE User equipment

UMTS Universal mobile telecommunications system

VoIP Voice over IP

Embodiments of the present invention relate to leveraging ECN for increasing efficiency of admission control in a network, for example in connection with voice over IP (VoIP).

In legacy mobile systems such as GSM, the voice service is supported in a non-transparent way by the radio access network subsystem, i.e. the radio access network subsystem is fully aware of the voice service being the voice service, and even takes an active role in providing the service, e.g. by supporting an audio codec transcoding functionality that reduces the amount of bandwidth needed for carrying audio information over the radio access. Being located in the radio access network subsystem and having direct access to the voice data, this transcoding functionality can take radio access network subsystem specific information into account when configuring the transcoding functionality, e.g. based on radio load or coverage information initiate transcoding to/from a codec with higher or lower bit rate. It can even change the properties of the transcoding for an ongoing conversation, e.g. reduce the codec bit rate if the user reaches the edge of the coverage area, or if the radio system carries a high load.

In more recent mobile systems, such as UMTS Long Term Evolution (LTE), voice services are provided via Voice over IP (VoIP) technology. I.e. the mobile system provides a generic transport capability for IP packets, which is in turn used to carry voice data. In this setup, the radio access network subsystem is typically not aware anymore as to what kind of service is provided above the IP protocol, i.e. the voice data is carried transparently through the radio access network subsystem.

In a typical IP network such as the Internet, all IP packets are treated equally and on a best effort basis. However, some services have stricter requirements than others regarding network performance, as described by parameters such as packet delay, packet delay variance (jitter) and bandwidth, called Quality of Service (QoS) requirements. To address this, the mobile system and especially the radio subsystem offer the possibility to differentiate different IP flows and to apply different treatment to them so that each one can receive treatment such that its requirements are met, especially for services such as voice which have quite demanding requirements, without needing to overachieve for services with more relaxed requirements. This differentiation capability is one feature that increases the resource efficiency of the system.

With the radio access network subsystem not being aware anymore as to what services are carried above the IP layer, the requirements of the different services are signaled as so-called QoS parameters from the core network, which has a better view at the services above the IP layer. So while the radio access network subsystem does not have itself knowledge of the services carried above the IP layer, it can to some degree adapt and optimize its behavior for supporting those services, based on and within the requirements as they can be signaled from the core network (CN).

The performance requirements for the voice service are among the strictest for any service. To support the low delay and jitter and the constant bandwidth needed, the network provides a so-called Guaranteed Bit Rate (GBR) transport service. The “guarantee” is given by specifically reserving a specific amount of resources for supporting the bit rate guaranteed for the GBR transport service. This is in contrast to so-called non-GBR transport services, where no guarantees need to be given as the services carried over these transport services are more tolerant to delay, jitter and bandwidth variations.

As the LTE radio access network subsystem is not involved in the media stream itself (as it is carried transparently across it above the IP layer), the radio access network subsystem cannot influence the media stream itself, as the radio access network subsystem of legacy mobile systems such as GSM could.

To mitigate this to some degree, 3GPP defines means by which the transparency of the media stream is abolished to some degree by giving the radio access network subsystem the means to signal to the end points of a voice stream that they should reduce the sending rate of the stream. Namely, two IP endpoints generating media streams between them can indicate support for so-called Explicit Congestion Notification (ECN) (as defined by IETF RFC 3168 and profiled by 3GPP 36.300 for this particular use) between them for the media streams, see FIG. 1.

FIG. 1 shows a simplified example for ECN workings in the downlink. In particular, between a receiver and a sender, a SIP (session initiation protocol) takes place, which is negotiated with a full set of codec rates, which are independent of a network level congestion. In this example, the sender and receiver operate according to RTCP/RTP (real time transport control protocol/real-time transport protocol) and have negotiated the use of ECN. That is, the packets will have an ECN field, which consists of two bits and is also referred to as CE (congestion experience) codepoint. In FIG. 1, the content of this field is indicated by ‘xx’.

If the RAN subsystem detects that two endpoints (e.g., sender and receiver as shown in FIG. 1) support and have agreed to use this mechanism for a particular stream, the RAN subsystem can ECN mark packets according to some local policy, e.g., by the ECN field described above. If the endpoints of the stream detect this marking, they can start to negotiate and take into use a different codec parameterization or different codec entirely to e.g. reduce the bit rate of the stream. The policy of the RAN subsystem for setting the ECN mark is not specified in detail, however, it should be used so as to increase capacity and/or improve coverage of the system.

In a wireless system it is necessary that the air interface load is kept constrained under predefined thresholds to avoid system instability, congestion and QoS degradation. Admission control, load control and packet scheduling strategies are utilized for this purpose at the eNodeB (evolved Node-B, the base station in LTE terminology).

Admission Control (AC) is applied to all new incoming real time traffic to ensure that the bit rate guarantee can be given over the air interface at the time the transport service is established for the new and existing traffic. The system keeps track of the available resources (i.e. those not committed to a guaranteed bit rate radio bearer, RAB), and only accepts the establishment of a new GBR RAB if there are enough uncommitted resources left to support this service without compromising the QoS of the existing GBR services. Otherwise, the establishment of the new GBR service is denied. Typically certain load thresholds which identify the feasibility-condition of the admitted load are pre-defined. The thresholds identify the maximum amount of resources which could be committed without generating congestion. The admission of a new RAB is granted only when with the admission such threshold would not be exceeded.

Load control (LC) and packet scheduling (PS) functionalities will take then care of situations where the load has exceeded the pre-defined threshold(s) and some active congestion handling mechanism may be required to resolve the congestion.

Those strategies include delaying or dropping packets or even dropping calls, causing degrading QoS and resulting in customer dissatisfaction.

The setting of such load thresholds is not trivial. Firstly, a maximum outage ratio per service class that an operator tolerates in its network should be accounted for. Typically 1-5% outage is assumed for voice traffic. This pre-requires a proper radio dimensioning to assure the correct downlink and uplink coverage probability. Secondly, a maximum call dropping ratio per service class that an operator tolerates in its network is considered. Typically <1% dropping ratio is assumed for voice traffic. Additionally the admission control estimates the resources to commit per RAB on the basis of an assumed activity factor. For instance in average terms a voice call will be typically characterized by a 50% activity due to an even proportion of a conversation which is identified as speech while the remaining proportion is identified with listening.

Therefore there exists a trade-off between the objective of not exceeding the maximum outage and dropping objectives. Due to the stricter dropping ratio criterion and the transparent way of handling services at the eNB, the thresholds are often set in a conservative manner.

Hence, the services and radio resources can not be optimally used.

### SUMMARY OF THE INVENTION

Thus, it is an object of the present invention to overcome the above problem of the prior art.

According to a first aspect of the present invention, this is accomplished by a an apparatus and a method, by which a penetration of terminals supporting a congestion indication scheme in a network or a part of the network is determined, and a load threshold is dynamically adjusted according to the penetration of terminals supporting a congestion indication scheme, wherein the load threshold is used for controlling load in the network or the part of the network.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1 shows a simplified example for ECN workings in the downlink;

FIG. 2 shows a simplified structure of an eNode-B according to an embodiment of the present invention;

FIG. 3 shows a simplified flow diagram according to an embodiment of the present invention; and

FIGS. 4A and 4B show potential voice capacity gain from a rate adaptation according to embodiments of the present invention.

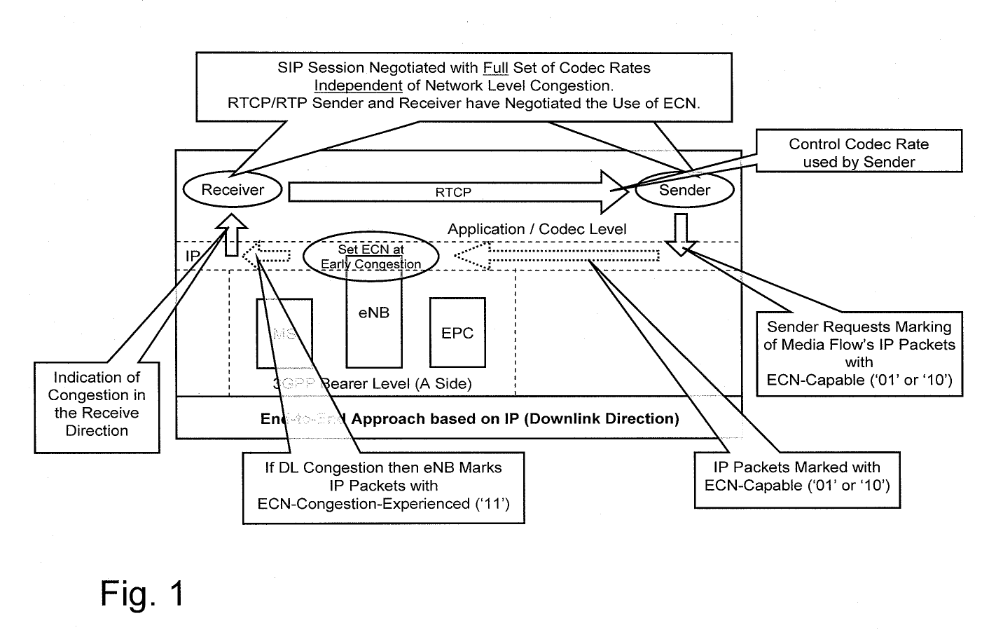

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

As described above, setting of the load thresholds in a network can be difficult, so that in the prior art, the thresholds are often set in a conservative manner.

According to several embodiments of the present invention, apparatuses and methods are provided by which a load threshold in a network or a part of the network can be dynamically adjusted according to the penetration of terminals supporting a congestion indication scheme, as for instance ECN.

In this way, namely by making use of specific properties of the carried service, and leveraging these, the efficiency of the system in terms of improved capacity and resource utilization can be enhanced by means of, e.g., overbooking.

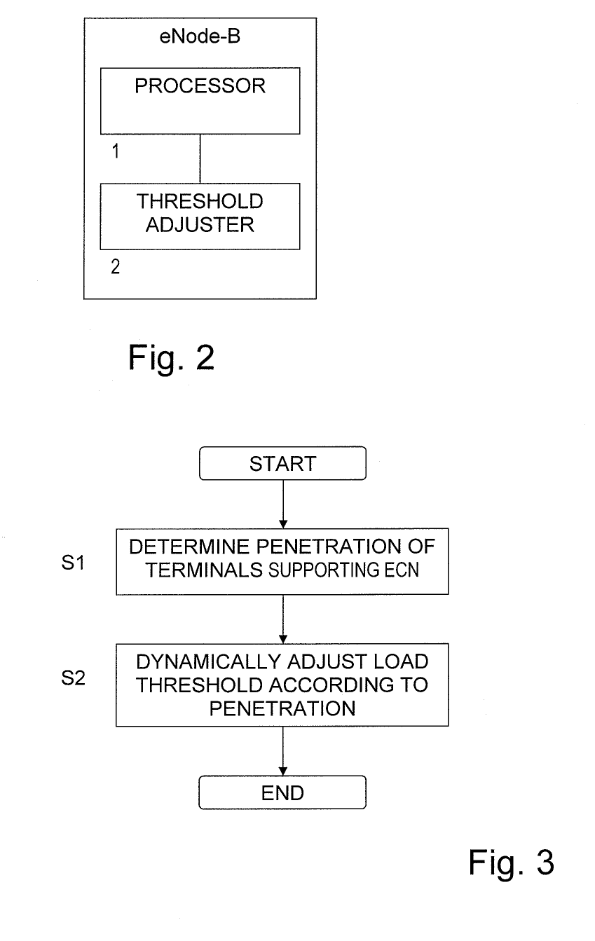

In the following, an apparatus according to an embodiment is described by referring to FIG. 2.

FIG. 2 shows an apparatus, which may be or may be part of a network control element such as an eNode-B, as it is shown in FIG. 2, for example. The eNode-B comprises a processor (processing means) 1 and a threshold adjuster (threshold adjusting means) 2. The processor 1 is configured to determine penetration of terminals supporting a congestion indication scheme in a network or a part of the network. The threshold adjuster 2 is able to dynamically adjust a load threshold according to a penetration of terminals supporting a congestion indication scheme. The load threshold can be used for controlling load in the network or the part of the network.

For example, the processor may be configured to control load in a network by determining the load in the network and comparing the determined load with the load threshold, so that a further control may be carried based on the result of the comparison.

It is noted that according to the above example, the processor 1 and the threshold adjuster 2 are described as separate elements. However, alternatively they could also be combined to a single element. For example, the processor could also comprise the function of the load determination unit.

In the following, a basic process according to an embodiment of the present invention is described by referring to FIG. 3.

In step S1, penetration of terminals supporting a congestion indication scheme in a network or a part of the network is determined, and in step S2, a load threshold according to the penetration of terminals supporting a congestion indication scheme in the network is dynamically adjusted.

Similar as described above, by using the load threshold, a load in a network or a part of the network may be controlled, e.g., by determining the load in the network and comparing the determined load with the load threshold.

In this way, the load threshold can be set optimally, since those terminals are taken into account which can use a congestion indication scheme.

The congestion indication scheme described above may be an explicit congestion notification (ECN); however, the embodiment is not limited to this specific notification.

Thus, a specific embodiment of the present invention proposes an ECN-aware admission control and load control. The ECN awareness at the AC is used to dynamically adjust the pre-defined load thresholds according to the penetration of terminals supporting the ECN feature. The higher the penetration the more aggressive thresholds can be set (overbooking). That is, the higher the penetration of such terminals, the higher the thresholds can be set. This penetration measure could be based on some statistics collected per operator and per site basis.

When load increases close to the load threshold indicating that congestion is approaching the ECN-based AC would “initi-ate” new calls which support ECN with a lower codec rate. Due to the ECN working in the above step, the radio AC may admit the new call possibly granting a lower bit rate than requested, and then upon first exchange of packets, it forces lowering of codec bit rate to be in line with the radio AC granted bit rate. As second step, if congestion is not yet solved the ECN awareness at the load control would allow to apply codec rate reduction for existing calls with ECN support.

That is, for example, let the load threshold be A. In case the load in the network is c1*A (with 0≦c1<1, for example c1=0.9) or higher, then the access control will initiate new calls supporting ECN only with a lower codec rate. When then the load in the network is c2*A (c2>c1 and 0≦c1<1, for example c2=0.95) or higher, the load control will apply the codec rate reduction for existing calls with ECN support.

The penetration described above relates, for example, to a single cell, a group of cells or for a whole network of an operator. That is, the penetration may be determined locally only for a single cell or a group of cells (i.e., how many terminals supporting ECN are currently present in the cell(s)), or for the whole network (i.e., how many terminals in the network of the operator support ECN).

The penetration of terminals supporting the congestion indication scheme (e.g., ECN) may be defined, for example, as a percentage of those terminals supporting the congestion indication scheme with respect to the number of all terminals present in the network or a part of the network (such as a cell or a group of cells).

That is, in case the penetration for a whole network is considered, the determination of the penetration of terminals supporting the congestion indication scheme may include receiving corresponding information from a central network management, for example. In case of considering the penetration for a single cell or a group of cells, the penetration can be detected from those terminals currently present in the cell(s). However, the determination of the penetration is not limited to these examples.

Thus, the scheme according to the present embodiment allows to increase the efficiency of the system in terms of improved capacity, and resource utilization could be enhanced by means of controlled overbooking. This efficiency is achieved without compromising QoS and dropping objectives.

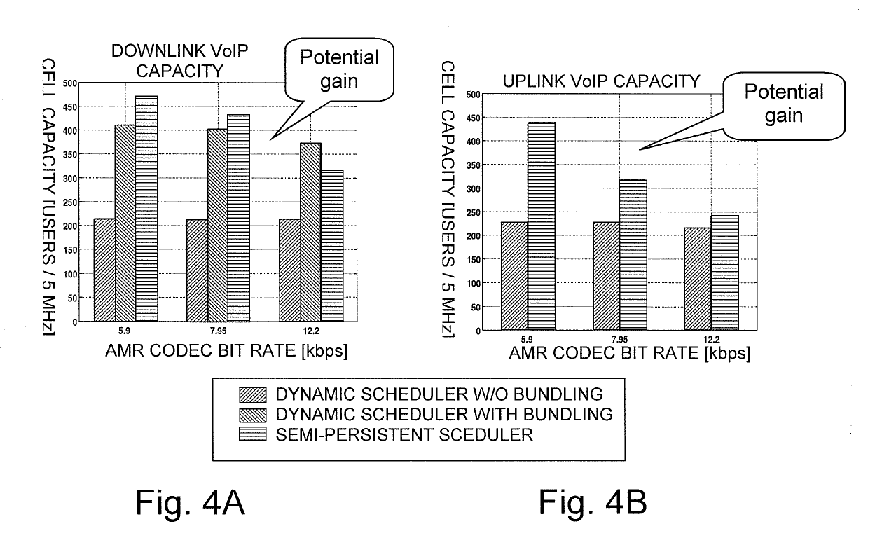

The potentials of the ECN usage are illustrated in FIGS. 4A and 4B for voice traffic. FIG. 4A shows the downlink VoIP capacity, and FIG. 4B shows the uplink VoIP capacity for 5 MHz frequency bandwidth and 3GPP Macro case #1 (e.g., 3GPP TS 25.814, Annex 2). The VoIP capacity, which delimits the QoS feasibility region of a cell, is commonly defined as the highest number of VoIP users that the system can support with at least 95% of the users satisfied.

In FIG. 4A, three different cases are shown: dynamic scheduler without packet bundling, dynamic scheduler with packet bundling and a semi-persistent scheduler, whereas in FIG. 4B dynamic scheduler without packet bundling and semi-persistent scheduler are shown. Both figures depict the VoIP capacities for 5.9, 7.95, and 12.2 kbps AMR (adaptive multi rate) codecs, respectively.

The figures illustrate that by means of decreasing the AMR voice codec rate, the VoIP capacity can be conveniently increased. This means that the network could perform overbooking in a safe manner (avoiding / limiting voice dropping and blocking) by adjusting the codec of new / existing calls with ECN support if needed.

It is noted that in the above-described embodiments, the congestion indication scheme has been described as an explicit congestion notification (ECN). However, the embodiment is not limited to this. For example, the congestion indication scheme may comprise an indicator which is included in each or some packets to be sent. Furthermore, also separate control information may be sent, by which the presence of congestion is informed.

Furthermore, in the embodiment described above, the apparatus in which the dynamic adjustment of the threshold is carried out is an eNode-B. However, this is only an example. The apparatus may also be only a part of an eNode-B, or may be another suitable network control element (or a part thereof) in which a control of the load in a network can be carried out.

According to a first aspect of several embodiments of the invention, an apparatus is provided which comprises
a processor configured to determine penetration of terminals supporting a congestion indication scheme in a network or a part of the network, and
a threshold adjuster configured to dynamically adjust a load threshold according to the penetration of terminals supporting a congestion indication scheme, the load threshold being used for controlling load in the network or the part of the network.

The first aspect may be modified as follows:

The processor may be configured to control load in the network or a part of the network by determining the current load in the network or the part of the network and comparing the determined load with the load threshold.

The processor may be configured to perform an admission control, a load control and/or packet scheduling for controlling the load in the network or the part of the network.

The processor may be configured to determine the penetration of terminals supporting the congestion indication scheme based on statistics.

The processor may be configured to collect the statistics per operator, site and/or cell basis.

The threshold adjuster may be configured to increase the load threshold in case the penetration of terminals supporting the congestion indication scheme is increased.

The processor may be configured to perform an access control, in which a codec rate for at least one new call supporting the congestion indication scheme is determined based on the current load.

The processor may be configured to perform a load control, in which a codec rate for at least one existing call supporting the congestion indication scheme is determined based on the current load.

According to a second aspect of several embodiments of the invention, a method is provided which comprises
determining penetration of terminals supporting a congestion indication scheme in a network or a part of the network, and
dynamically adjusting a load threshold according to the penetration of terminals supporting a congestion indication scheme, the load threshold being used for controlling load in the network or the part of the network.

The second aspect may be modified as follows:

The method may further comprise controlling load in the network or the part of the network by determining the current load in the network or the part of the network and comparing the determined load with a load threshold.

Controlling load in the network or the part of the network may comprise an admission control, a load control and/or packet scheduling.

The penetration of terminals supporting the congestion indication scheme may be determined based on statistics.

The statistics may be collected per operator, site and/or cell basis.

The load threshold may be increased in case the penetration of terminals supporting the congestion indication scheme is increased.

Controlling load of the network or the part of the network may comprise an access control, in which a codec rate for at least one new call supporting the congestion indication scheme is determined based on the load.

Controlling load of the network or the part of the network may comprise a load control, in which a codec rate for at least one existing call supporting the congestion indication scheme is determined based on the load.

According to a third aspect of several embodiments of the present invention, a computer program product is provided which comprises code means for performing a method according to any one of the second aspect and its modifications when run on a computer, a processing means or module.

The computer program product may be embodied on a computer-readable medium.

According to a fourth aspect of several embodiments of the invention, an apparatus is provided which comprises
means for determining penetration of terminals supporting a congestion indication scheme in a network or a part of the network, and
means for dynamically adjusting a load threshold according to the penetration of terminals supporting a congestion indication scheme, the load threshold being used for controlling load in the network or the part of the network.

The fourth aspect may be modified as follows:

The apparatus may comprise means for controlling load in the network or a part of the network by determining the current load in the network or the part of the network and comparing the determined load with the load threshold.

The apparatus may comprise means for performing an admission control, a load control and/or packet scheduling for controlling the load in the network or the part of the network.

The apparatus may comprise means for determining the penetration of terminals supporting the congestion indication scheme based on statistics.

The apparatus may comprise means for collecting the statistics per operator, site and/or cell basis.

The apparatus may comprise means for increasing the load threshold in case the penetration of terminals supporting the congestion indication scheme is increased.

The apparatus may comprise means for performing an access control, in which a codec rate for at least one new call supporting the congestion indication scheme is determined based on the current load.

The apparatus may comprise means for performing a load control, in which a codec rate for at least one existing call supporting the congestion indication scheme is determined based on the current load.

All aspects described above may be modified as follows:

The penetration of terminals supporting the congestion indication scheme may be defined as a percentage of those terminals supporting the congestion indication scheme with respect to the number of all terminals present in the network or the part of the network.

The part of the network may comprise a cell and/or a group of cells.

It is to be understood that any of the above modifications can be applied singly or in combination to the respective aspects and/or embodiments to which they refer, unless they are explicitly stated as excluding alternatives.

For the purpose of the present invention as described herein above, it should be noted that
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above, eNode-B etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and examples described above are provided for illustrative purposes only and are in no way intended that the present invention is restricted thereto. Rather, it is the intention that all variations and modifications be included which fall within the spirit and scope of the appended claims.

1. An apparatus, comprising
a processor configured to determine penetration of terminals supporting a congestion indication scheme in a network or a part of the network, and
a threshold adjuster configured to dynamically adjust a load threshold according to the penetration of terminals supporting a congestion indication scheme, the load threshold being used for controlling load in the network or the part of the network.

2. The apparatus according to claim 1, wherein the processor is configured to control load in the network or a part of the network by determining the current load in the network or the part of the network and comparing the determined load with the load threshold.

3. The apparatus according to claim 2, wherein the processor is configured to perform an admission control, a load control and/or packet scheduling for controlling the load in the network or the part of the network.

4. The apparatus according to claim 1, wherein the processor is configured to determine the penetration of terminals supporting the congestion indication scheme based on statistics.

5. The apparatus according to claim 4, wherein the processor is configured to collect the statistics per operator, site and/or cell basis.

6. The apparatus according to claim 1, wherein the threshold adjuster is configured to increase the load threshold in case the penetration of terminals supporting the congestion indication scheme is increased.

7. The apparatus according to claim 2, wherein the processor is configured to perform an access control, in which a codec rate for at least one new call sup-porting the congestion indication scheme is determined based on the current load.

8. The apparatus according to claim 2, wherein the processor is configured to perform a load control, in which a codec rate for at least one existing call supporting the congestion indication scheme is determined based on the current load.

9. The apparatus according to claim 1, wherein the penetration of terminals supporting the congestion indication scheme is defined as a percentage of those terminals supporting the congestion indication scheme with respect to the number of all terminals present in the network or the part of the network.

10. The apparatus according to claim 1, wherein the part of the network comprises a cell and/or a group of cells.

11. A method, comprising
determining penetration of terminals supporting a congestion indication scheme in a network or a part of the network, and
dynamically adjusting a load threshold according to the penetration of terminals supporting a congestion indication scheme, the load threshold being used for controlling load in the network or the part of the network.

12. The method according to claim 11, further comprising controlling load in the network or the part of the network by determining the current load in the network or the part of the network and comparing the determined load with a load threshold.

13. The method according to claim 12, wherein controlling load in the network or the part of the network comprises an admission control, a load control and/or packet scheduling.

14. The method according to claim 11, wherein the penetration of terminals supporting the congestion indication scheme is determined based on statistics.

15. The method according to claim 14, wherein the statistics are collected per operator, site and/or cell basis.

16. The method according to claim 11, wherein the load threshold is increased in case the penetration of terminals supporting the congestion indication scheme is increased.

17. The method according to claim 12, wherein controlling load of the network or the part of the network comprises an access control, in which a codec rate for at least one new call supporting the congestion indication scheme is determined based on the load.

18. The method according to claim 12, wherein controlling load of the network or the part of the network comprises a load control, in which a codec rate for at least one existing call supporting the congestion indication scheme is determined based on the load.

19. The method according to claim 11, wherein the penetration of terminals supporting the congestion indication scheme is defined as a percentage of those terminals supporting the congestion indication scheme with respect to the number of all terminals present in the network or the part of the network.

20. The method according to claim 11, wherein the part of the network comprises a cell and/or a group of cells.

21. A computer program product comprising code means for performing a method according to claim 11 when run on a processing means or module.

22. The computer program product according to claim 21, wherein the computer program product is embodied on a computer-readable medium.
